(19) United States
(12) Patent Application Publication
(10) Pub. No.: US 2014/0156329 A1
(43) Pub. Date: Jun. 5, 2014

(54) Canonical Availability Representations For Bills Of Materials

(71) Applicant: DASSAULT SYSTEMES DELMIA CORP., Auburn Hills, MI (US)

(72) Inventors: Moon Ho Hwang, Auburn Hills, MI (US); Judson Plapp, Auburn Hills, MI (US); Christof Stadler, Velizy-Villacoublay Cedex (FR)

(73) Assignee: Dassault Systemes DELMIA Corp., Auburn Hills, MI (US)

(21) Appl. No.: 13/691,706

(22) Filed: Nov. 30, 2012

(51) Int. Cl. G06Q 10/08

(52) U.S. Cl. CPC G06Q 10/0875; G06Q 10/063114
USPC 705/7.15

(57) ABSTRACT

A computer-implemented method for validating a bill of material (BOM) structure having a plurality of nodes includes creating a directed acyclic graph of a process based on the BOM, wherein the directed acyclic graph includes the BOM structure and a process network, determining a status of at least one process in the process network, and comparing the status of the process to an associated node.

### BACKGROUND OF THE INVENTION

The embodiments described herein relate generally to engineering decision-making technologies and, more particularly, to decision-making technologies related to manufacturing engineering, industrial engineering, and the like.

As consumer and industrial products become more complex, the structures, or bills of material (BOM) structures, of those products have become more complicated in terms of the number and types of parts used. However, there exists no known methodology to validate that a sequence of manufacturing and/or supply chain processes can finally produce a target product. Specifically, there exists no known representation method that identifies the resulting status of a manufacturing process in a unique way in comparison to a product structure. Rather, known solutions use flat text based BOM validation, which is not scalable when BOM structures include many parts, assemblies, and/or subassemblies. Moreover, such flat text based BOM analysis does not enable BOM structures to be assembled in multiple ways. Furthermore, such flat text based BOM analysis does not enable BOM structures to be purchased in part or in whole. Accordingly, it would be beneficial to clarify the equivalencies between different representations, i.e., between manufacturing processes and the parts of a product structure that are produced by those processes.

### SUMMARY OF THE INVENTION

In one aspect, a computer-implemented method is provided for validating a bill of material (BOM) structure having a plurality of nodes. The computer-implemented method includes creating a directed acyclic graph of a process based on the BOM, wherein the directed acyclic graph includes the BOM structure and a process network, determining a status of at least one process in the process network, and comparing the status of the process to an associated node.

In another aspect, a computer is provided for use in validating a BOM structure having a plurality of nodes. The computer includes a memory area configured to store data representative of the plurality of nodes and the BOM structure. The computer also includes a processor coupled to the memory area and configured to create a directed acyclic graph of a process based on the BOM, wherein the directed acyclic graph includes the BOM structure and a process network, determine a status of at least one process in the process network, and compare the status of the process to an associated node.

In another aspect, a computer program product includes one or more non-transitory computer-readable storage media having computer-executable components for use in validating a BOM structure having a plurality of nodes. The components include a graph component that when executed by a processor causes the processor to create a directed acyclic graph of a process based on the BOM, wherein the directed acyclic graph includes the BOM structure and a process network. The components also include a status component that when executed by a processor causes the processor to determine a status of at least one process in the process network and compare the status of the process to an associated node.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is an illustration of a possible graph for bill of materials (BOM) analysis.

FIGS. 2A-2C are illustrations of exemplary BOM structures.

FIGS. 3A and 3B are additional illustrations of BOM structures.

FIGS. 4A and 4B are further illustrations of BOM structures.

FIG. 5 is a schematic block diagram of an exemplary computer architecture for use in validating a BOM.

FIGS. 6A-6F are examples of directed acyclic graphs.

FIG. 7 is a schematic block diagram of an exemplary computer system for use in validating a BOM.

FIG. 8 is a flowchart that illustrates an exemplary computer-implemented method for use in validating a BOM.

### DETAILED DESCRIPTION OF THE INVENTION

A description of example embodiments of the invention follows.

Exemplary embodiments of computer-implemented methods, computer systems, computers, and computer program products for use in validating a BOM structure having a plurality of nodes are described herein. The embodiments described herein facilitate defining equivalence between different representative forms in a BOM, wherein the equivalence enables validation that the status of an assembly process is what is to be produced by that process. The embodiments described herein thus enable fast and flexible analysis of BOM structures and BOM assembly processes.

Exemplary technical effects of computer-implemented methods, computer apparatus, computer systems, and computer program products described herein include at least one of: (a) loading or acquiring a BOM into a computer; (b) based on the BOM, defining material nodes representative of materials in the BOM and material edges that connect the material nodes in a BOM structure; (c) also based on the BOM, defining process nodes representative of provide processes (i.e., where materials are procured) and assemble processes (i.e., where materials are assembled from sub-parts) and process edges that connect the process nodes in a process network; (d) creating a directed acyclic graph from the BOM structure and the process network such that each process node in the process network corresponds to a material node in the BOM structure; (e) calculating a status of the process network based on the minimal canonical form of the process network; (f) comparing the status of the process network to the BOM structure; and (g) marking the BOM as either valid or invalid in a memory area, based on the comparison.

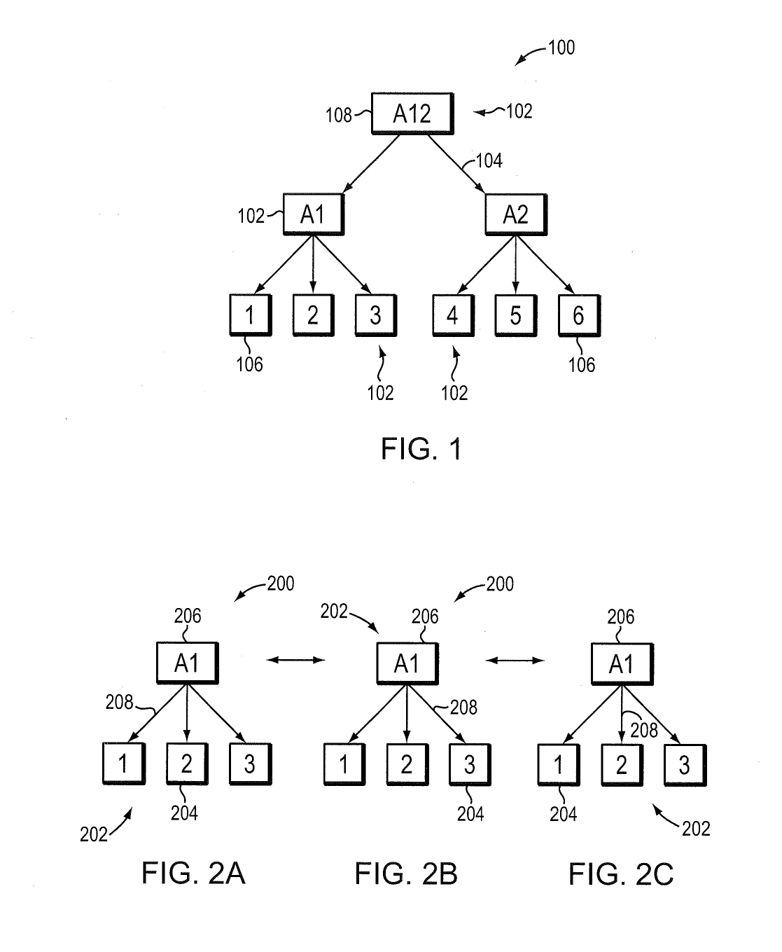

FIG. 1 is an illustration of a possible graph for BOM structure analysis. Specifically, FIG. 1 illustrates a graph 100 that represents a BOM using a tree representation. The graph 100 includes a plurality of nodes 102. The membership of the BOM can be represented as a finite set of materials (e.g., nodes) and a finite set of edges that connect the materials. For example, the BOM can be represented mathematically as shown in Equation (1):

B=(M,E_{M}) Eq. (1)

where M is a finite set of materials, and E_{M}⊂M×M is a finite set of edges 104 such that (m1,m)∈E_{M} implies that there is no m2∉M:m2≠m1 and (m2,m)∈E_{M}. An edge (m,m′)∈E_{M} of a tree can be symbolized by m→m′. Here, m and m′ are called the source and the target of the edge (m,m′)∈E_{M}, respectively.

Moreover, as shown in FIG. 1, the set of child nodes or materials of a given material m in M is denoted by children(m), which is the set of targets of the edges starting from m as shown in Equation (2):

children(m)={m′∈M:(m,m′)∈E_{M}} Eq. (2)

If a component m has no child material such that children(m)={ } then m is labeled as a leaf. The set of leaf material of a given BOM B=(M,E_{M}) is denoted by leaf(B)={m∈M:m is a leaf}. In FIG. 1, the leaf nodes 106 may be represented as leaf(B)={1,2,3,4,5,6}.

In contrast, the set of parent material nodes of a given component m in M is denoted by parent(m), which is the set of sources of the edges ending to m as shown in Equation (3):

parent(m)={m′∈M:(m′,m)∈E_{M}} Eq. (3)

If a given node m has no parent nodes such that parent(m)={ } then m is labeled as a root. Given a BOM B=(M,E_{M}), the root node 108 is denoted by root(B)=m∈M. In FIG. 1, the root node 108 can be represented as root(B)={A12}.

Moreover, the ancestors of m are defined as the set of recursive parents from node m as shown in Equation (4):

ancestors(m)={m″∈parent(m′):m′∈ancestors(m)∪{m}} Eq. (4)

The descendents of m are defined as the set of recursive children from node m as shown in Equation (5):

descendents(m)={m″∈children(m′):m′∈descendents(m)∪{m}} Eq. (5)

For example in FIG. 1, the ancestors of node {1} can be expressed as nodes {A1} and {A12}, or ancestors(1)={A1,A12}, while the descendents of node {A12} can be expressed as nodes {A1}, {A2}, and nodes {1} through {6}, or descendents(A12)={A1,A2,1,2,3,4,5,6}.

FIGS. 2A-2C are illustrations of exemplary BOM structures represented as graphs 200 to explain the concepts of availability, equivalence, and closure of available nodes. Similar to the graph 100 shown in FIG. 1, graphs 200 include a plurality of nodes 202, such as leaf nodes 204 and a root node 206. Moreover, similar to FIG. 1, each node 202 is a material m and each node is connected to one or more other nodes 202 by an edge E 208. For a given BOM B=(M,E_{M}), a material m in the set of materials M is available if m is produced or purchased. More specifically, a material m is available if and only if all of its children children(m) are available.

In the BOM structures shown in FIGS. 2A-2C, all available sets {A1}, {1,2,3}, and {A1,1,2,3} are equivalent in terms of availability. For example, in FIG. 2A the set {A1} is available; in FIG. 2B the set {1,2,3} is available; and in FIG. 2C the set {A1,1,2,3} is available. Because node A1 is a parent of each of the set {1,2,3}, node A1 is available only when all of the set {1,2,3} is available as shown in FIG. 2B. Moreover, because node A1 is shown as available in each of FIGS. 2A-2C, each of the graphs 200 of FIGS. 2A-2C are equivalent.

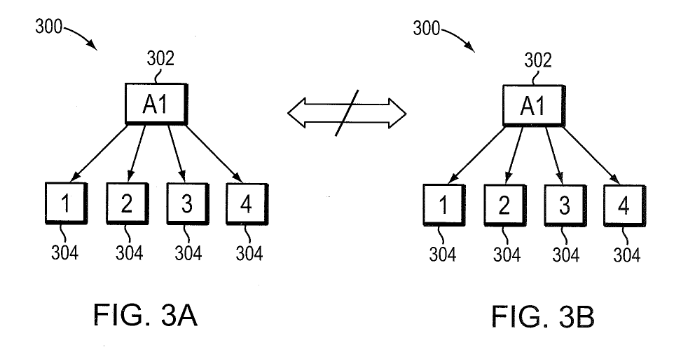

FIGS. 3A and 3B are also illustrations of BOM structures, represented as graphs 300 to further explain the concepts of availability, equivalence, and closure of available nodes. However, the graphs 300 shown in FIGS. 3A and 3B are not equivalent. As shown in FIG. 3A, root node A1 302 is available, which means that each child node 304 in the set {1,2,3,4} is available. However, only child nodes 304 in the set {1,2,3} are available in FIG. 3B, which means that root node A1 302 is not available.

Given a set of available nodes A⊂M in a BOM B=(M,E_{M}), a set that consists of unions of all equivalent representations can be expressed as shown in Equation (6):

AClosure(A)=U_{r∈{M′⊂M:M′is equivalent to A}}r Eq. (6)

For example, in the BOM structure shown in FIGS. 2A-2C, AClosure({A1})={A1,1,2,3} which is expressly shown in FIG. 2C.

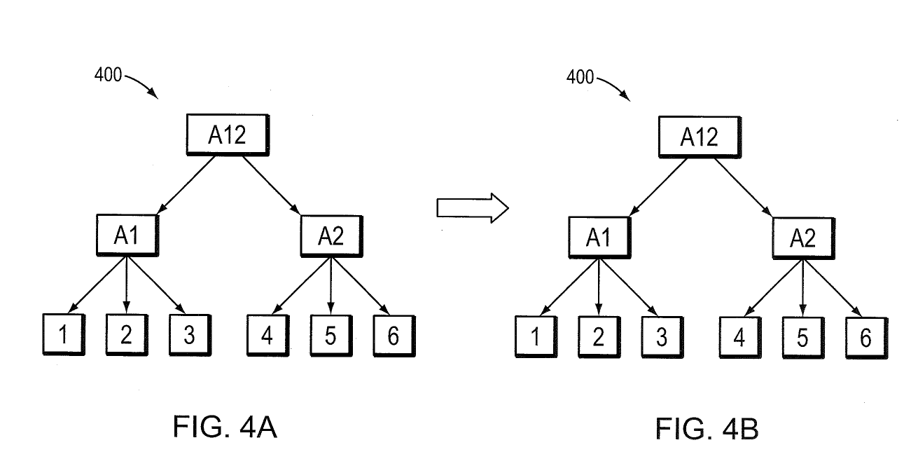

FIGS. 4A and 4B are illustrations of BOM structures, represented as graphs 400 to explain the concept of canonical forms of available nodes. The minimal canonical form of available nodes A is denoted by MinCanonical(A), and is defined by the set of nodes whose parents are not included in the closure AClosure(A) as shown in Equation (7):

MinCanonical(A)={m∈AClosure(A):parent(m)∉AClosure(A)} Eq. (7)

For example, in the structure of FIGS. 2A-2C, the minimal canonical form is {A1} because that is the minimal expression of all available nodes 202 in the graph 200. However, the minimal canonical form of the graph 400 shown in FIG. 4A is {A1,6}, as shown in FIG. 4B, because availability of nodes {1,2,3} can be minimized as {A1} while availability of node {6} cannot be minimized further.

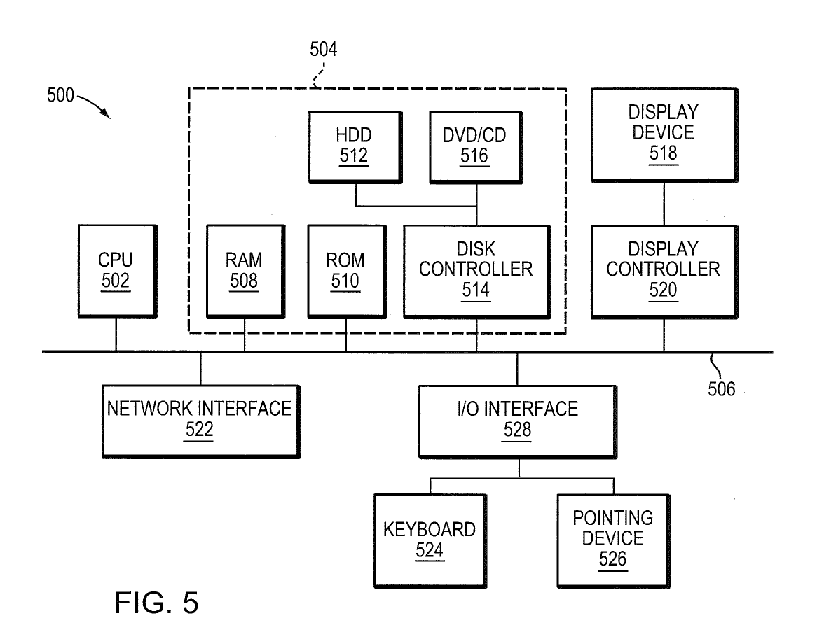

FIG. 5 is a schematic block diagram of an exemplary computer architecture 500 for use in validating a BOM structure. In an exemplary embodiment, the computer architecture 500 includes one or more processors 502 (CPU) that performs the methods described herein and/or any additional methods that may be related to those described herein. It should be understood that the term “processor” refers generally to any programmable system including systems and microcontrollers, reduced instruction set circuits (RISC), application-specific integrated circuits (ASIC), programmable logic circuits, and/or any other circuit or processor capable of executing the functions described herein. The above examples are exemplary only and, thus, are not intended to limit in any way the definition and/or meaning of the term “processor.”

The steps of the methods described herein and/or any additional methods that may be related to those described herein may be stored as computer-executable instructions in, for example, a memory area 504 that is operably and/or communicatively coupled to the processor 502 by a system bus 506, and for use in storing data, such as a directed acyclic graph that includes the BOM structure and a process network; data representative of a set of material nodes related to materials used in a BOM; data representative of a set of process nodes related to processes used to assemble and/or procure the materials used in the and including a set of provide process nodes related to processes in which materials are provided whole and a set of assemble process nodes related to processes in which materials are assembled; data representative of a set of process edges that connect the process nodes; data representative of a set of material edges that connect the material nodes; and/or any other suitable data related to BOM structures.

A “memory area,” as used herein, refers generally to any means of storing non-transitory program code and instructions executable by one or more processors to aid in validating a BOM structure, and/or for use in performing the methods described herein and/or additional methods that may be related to those described herein. The memory area 504 may include one, or more than one, forms of memory. For example, the memory area 504 may include random-access memory (RAM) 508, which can include non-volatile RAM, magnetic RAM, ferroelectric RAM, and/or other forms of RAM. The memory area 504 may also include read-only memory (ROM) 510 and/or flash memory and/or electrically-programmable read-only memory (EEPROM). Any other suitable magnetic, optical, and/or semiconductor memory, such as a hard-disk drive (HDD) 512, by itself or in combination with other forms of memory, may be included in the memory area 504. The HDD 512 may also be coupled to a disk controller 514 for use in transmitting and receiving messages to and from the processor 502. Moreover, the memory area 504 may also be, or may include, a detachable or removable memory 516, such as a suitable cartridge disk, CD-ROM, DVD, or USB memory. The above examples are exemplary only and, thus, are not intended to limit in any way the definition and/or meaning of the term “memory area.”

The computer architecture 500 also includes a display device 518 that is coupled, such as operatively coupled, to a display controller 520. The display controller 520 receives data via the system bus 506 for display by the display device 518. The display device 518 may be, without limitation, a monitor, a television display, a plasma display, a liquid crystal display (LCD), a display based on light-emitting diodes (LED), a display based on organic LEDs (OLED), a display based on polymer LEDs, a display based on surface-conduction electron emitters, a display including a projected and/or reflected image, or any other suitable electronic device or display mechanism. Moreover, the display device 518 may include a touchscreen with an associated touchscreen controller (neither shown in FIG. 5). The above examples are exemplary only and, thus, are not intended to limit in any way the definition and/or meaning of the term “display device.”

In addition, the computer architecture 500 includes a network interface 522 for use in communicating with a network (not shown in FIG. 5). Moreover, the computer architecture 500 includes one or more input devices, such as a keyboard 524 and/or a pointing device 526, such as a roller ball, mouse, touchpad, and the like. The input devices are coupled to and controlled by an input/output (I/O) interface 528, which is further coupled to the system bus 506.

A description of the general features and functionality of the display device 518, keyboard 524, pointing device 526, as well as the display controller 520, disk controller 514, network interface 522, and I/O interface 528 is omitted herein for brevity as these features are known.

During operation, a computer having the computer architecture 500 of FIG. 5 validates a BOM structure. The processor 502 creates a directed acyclic graph of a process based on the BOM, wherein the directed acyclic graph includes the BOM structure and a process network. For example, the processor 502 locates data in the memory area 504 representative of material nodes of the BOM structure and process nodes of the process network and creates the directed acyclic graph based on that data. In an embodiment, the directed acyclic graph is defined as shown in Equation (8) where N is the directed acyclic graph, V is a set of materials and processes in the directed acyclic graph, and E is a set of edges connecting the materials in one portion of the directed acyclic graph and connecting the processes in another portion of the directed acyclic graph:

N=(V,E) Eq. (8)

More specifically, the processor 502 defines the set of materials and processes V as a union of a set materials M and a set of processes P, and stores in the memory area 504 associations between the individual materials in the set of materials of M and between the individual processes in the set of processes P. Moreover, the processor 502 defines the set of processes P as a union of a set of “provide” processes P_{P} and a set of “assemble” processes P_{A}. The provide processes P_{P} are processes in which materials are provided whole, such as purchased whole from suppliers or vendors. The assemble processes P_{A} are processes in which materials are assembled from parts, assemblies, or subassemblies. The processor 502 stores in the memory area 504 associations between the individual processes in the set of provide processes P_{P} and in the set of assemble processes P_{A}. The set of edges E is defined by the processor 502 as a union of a set of material edges E_{M} between the material nodes, a set of process precedence edges E_{P} between the assemble process nodes, and a set of providing edges E_{PM} between the provide process nodes. The processor 502 also stores data in the memory area 504 related to the sets of edges E, E_{M}, E_{P}, and E_{PM}. To create the directed acyclic graph, the processor 502 determines from the BOM the necessary elements, including materials M, processes P, and edges E. The processor 502 links nodes together in the BOM structure, using material edges E_{M}, based on those materials M that are connected or that depend on each other. Moreover, the processor 502 links nodes together in the process network, using process precedence edges E_{P} and providing edges E_{PM}, based on those processes P that are used to provide or assemble the materials.

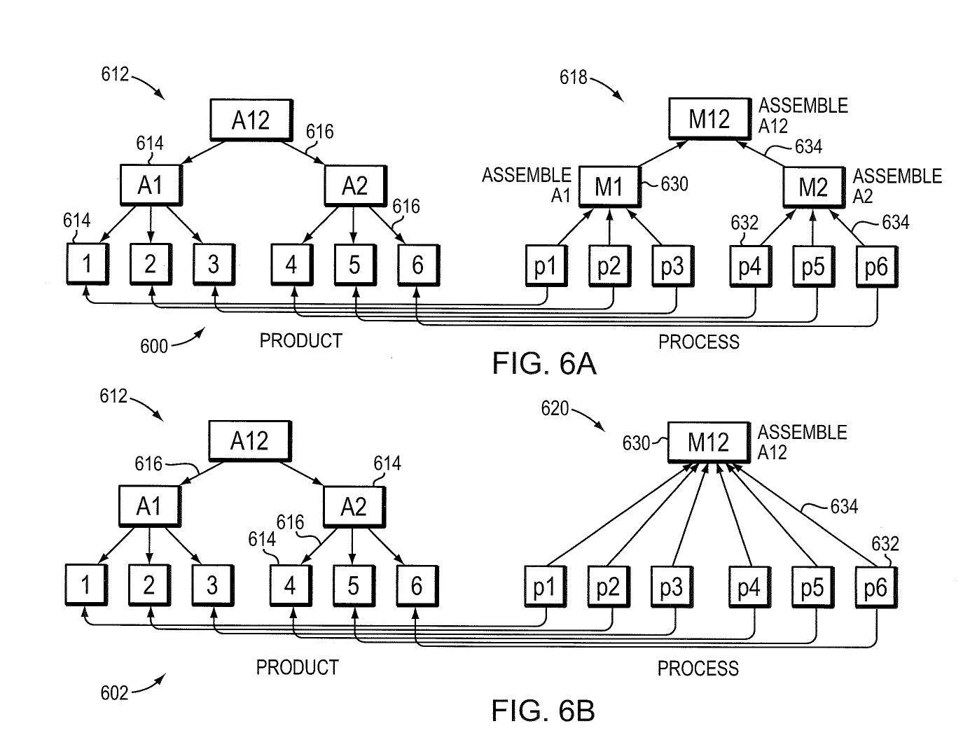

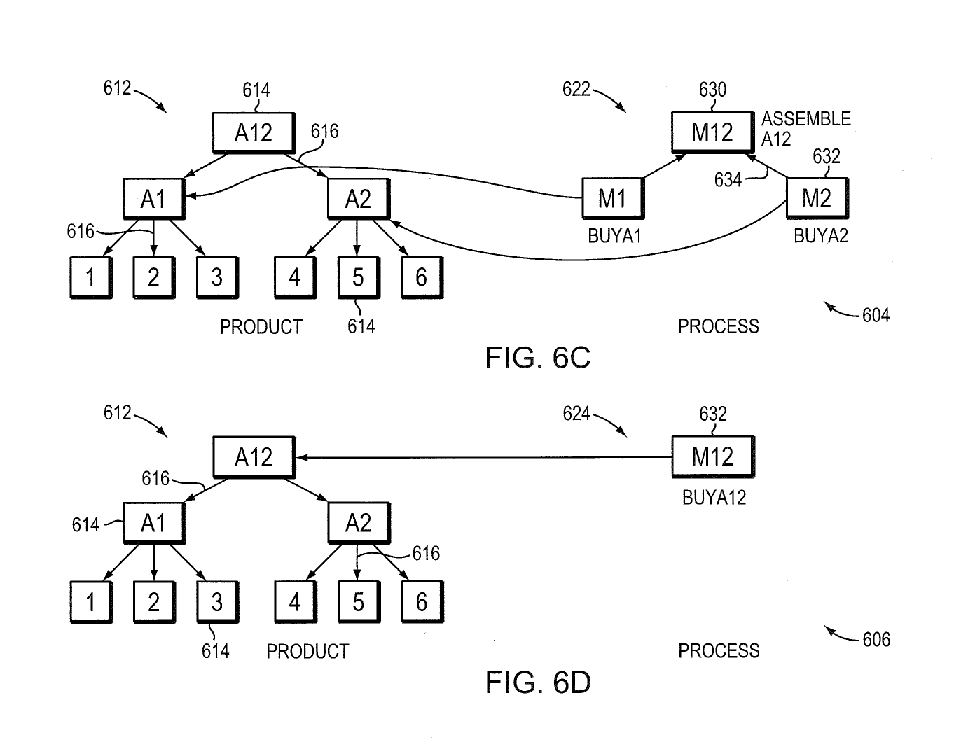

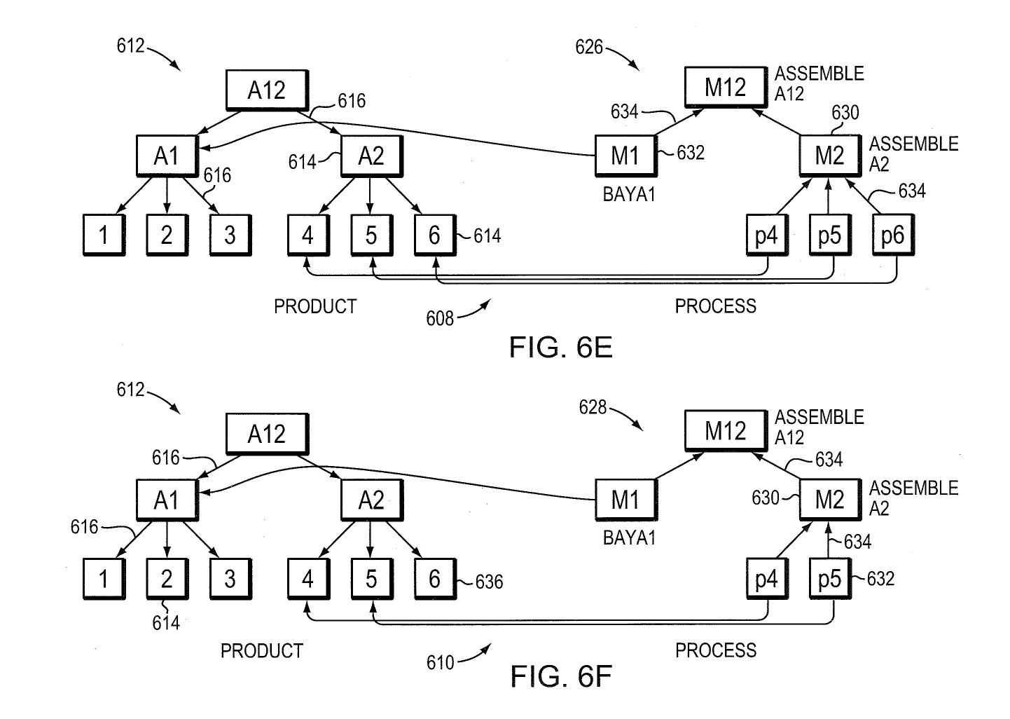

FIGS. 6A-6F are examples of directed acyclic graphs 600-610, respectively. Each directed acyclic graph 600-610 includes a BOM structure 612. Each BOM structure 612 includes a set of material nodes 614 and a set of material edges 616 that connect the material nodes 614, such that the BOM structure forms a tree graph like those discussed above. Moreover, each directed acyclic graph 600-610 includes a process network 618-628, respectively. Each process network 618-628 includes a set of assemble process nodes 630 and/or provide process nodes 632 connected by process edges 634. The process edges 634 include process precedence edges and providing edges, as described above.

Referring again to FIG. 5, after creating the directed acyclic graph, the processor 502 determines a status of a process in the process network. In some embodiments, the processor 502 determines a status of each process in the process network. In other embodiments, the processor 502 determines a status of only certain processes, such as those that have leaf nodes. Specifically, the processor 502 determines the status as a minimal canonical form of the process network with respect to one or more processes. In an exemplary embodiment, the status of a given process p in P is defined (1) if p is a “provide” process, it is implementing material which is imp(p); otherwise, i.e. p is a “assemble” process, the minimum canonical representation of unions of status of source processes to p. Formally, it can be written in Equation (9):

$$state ( p ) = \{ \begin{matrix}\{ m \} & if p ∈ {P}_{P} , imp ( p ) = m , \\ Min Canonical ( {⋃ state ( {p}^{′} )}_{{p}^{′} ∈ InV ( p , {E}_{P} )} ) & othrewise , i . e . p ∈ {P}_{A}\end{matrix} \qquad Eq . ( 9 )$$

where lnV(p,E_{P})={p′∈P:(p′,p)∈E_{P}} is the set of inputting processes to process p in terms of E_{P}.

Referring again to FIG. 5, the processor 502 then compares the minimal canonical form to a corresponding material node in the BOM structure. Accordingly, during setup of the directed acyclic graph, the processor 502 stores in the memory area 504 a link between each process node in the process network and a corresponding material node in the BOM structure that is a product of that process node. The BOM structure and/or the process network is valid if the status of the chosen process node matches the corresponding material node. If the two do not match, then the BOM structure and/or the process network is invalid. The processor 502 stores a state of the BOM in the memory area 504.

FIGS. 6A-6F can be referred to as examples of the process described above. In FIG. 6A, each process node 632 has a corresponding materials node 614. For example, process node p1 corresponds to material node 1 and process node M2 corresponds to material node A2. Using Equation (9) above, if the state of process node M2 matches material node A2, then process node M2 is valid. Similarly, if the state of process node M12 matches material node A12, then process node M12 is valid. Because the minimal canonical form of process node M12 does match the minimal canonical form of materials node A12, the entire BOM is valid.

Similarly, the minimal canonical form of process network 620 in FIG. 6B match the minimal canonical form of its corresponding BOM structure 612. Accordingly, the process network 620 and BOM structure 612 are valid for that BOM. This is also true of the BOMs reflected in the directed acyclic graphs 604-608 shown in FIGS. 6C-6E, respectively.

However, the process network 628 and BOM structure 612 are invalid for the directed acyclic graph 610 shown in FIG. 6F. The minimal canonical form of the process network 628 does not match the minimal canonical form of the BOM structure 612 because the leaf level nodes are different. For example, material node 636 does not have a corresponding process node in the process network 628. Accordingly, the contents of the BOM structure 612 are different than the contents of the process network 628. Specifically, the state of process network 628 is based on the minimal canonical form of the process network 628, such that state(M12)={A1,4,5}. This does not match the minimal canonical form of the BOM structure 612 so the BOM is invalid.

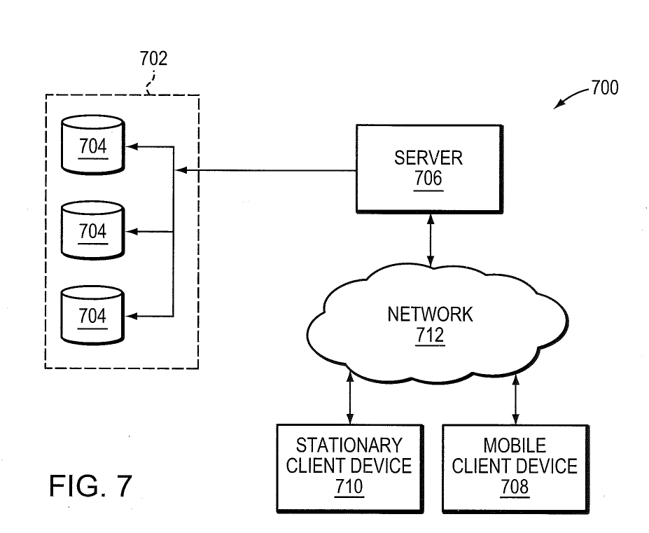

FIG. 7 is a schematic block diagram of an exemplary computer system 700 for use in validating a BOM structure, and/or for use in performing the methods described herein and/or additional methods that may be related to those described herein. In an exemplary embodiment, a memory area 702 includes one or more storage devices 704 for use in storing data, such as a directed acyclic graph that includes the BOM structure and a process network; data representative of a set of material nodes related to materials used in a BOM; data representative of a set of process nodes related to processes used to assemble and/or procure the materials used in the and including a set of provide process nodes related to processes in which materials are provided whole and a set of assemble process nodes related to processes in which materials are assembled; data representative of a set of process edges that connect the process nodes; data representative of a set of material edges that connect the material nodes; and/or any other suitable data related to BOM structures.

In some embodiments, the memory area 702 is coupled to a server system 706, which is in turn coupled to client devices such as one or more mobile client devices 708 and/or one or more stationary client devices 710, via a network 712. Mobile client devices 708 may be any mobile device including, but not limited to only including, laptop computers, tablet computers, and/or smartphones. Stationary client devices 710 may be any device that is generally not mobile, such as desktop computers and the like. The storage devices 704 may be embodied as one or more databases, may be located at a single or at multiple geographical sites, or may be integrated with a server system 706.

As can be appreciated, the network 712 can be a public network, such as the Internet, or a private network such as an LAN or WAN network, or any combination thereof and can also include PSTN or ISDN sub-networks. The network 712 can also be wired, such as an Ethernet network, or can be wireless such as a cellular network including EDGE, 3G, and 4G wireless cellular systems. The wireless network can also be WiFi, Bluetooth, or any other wireless form of communication that is known. Thus, the network 712 is merely exemplary and in no way limits the scope of the present advancements.

The client devices 708 and 710 can be any suitable computer architecture such as the one described above with reference to FIG. 5, or any other computing architecture that is known. Moreover, it should be understood that the server system 706 is configured to perform the methods described herein and/or any additional methods that may be related to those described herein.

The server system 706 stores the computer-readable instructions to execute the processes described herein, and provides these instructions via the network 712 to the client devices 708 and 710. Moreover, the server system 706 can also provide data from the memory area 702 as needed to the client devices 708 and 710 such that the client devices 708 and 710 execute the processes described above. As such, FIG. 7 includes implementations of the computer system 700 via cloud computing, distributed computing, and the like.

During operation, computer system 700 operates substantially similar to the computer architecture 500 shown in FIG. 5. However, the server system 706 performs the operations described with respect to the processor 502 of FIG. 5. For example, the server system 706 creates a directed acyclic graph of a process based on the BOM, wherein the directed acyclic graph includes the BOM structure and a process network. For example, the server system 706 locates data in the memory area 702 representative of material nodes of the BOM structure and process nodes of the process network and creates the directed acyclic graph based on that data. More specifically, the server system 706 defines the set of materials and processes V as a union of a set materials M and a set of processes P, and stores in the memory area 702 associations between the individual materials in the set of materials of M and between the individual processes in the set of processes P.

Moreover, the server system 706 defines the set of processes P as a union of a set of “provide” processes P_{P} and a set of “assemble” processes P_{A}. The provide processes P_{P} are processes in which materials are provided whole, such as purchased whole from suppliers or vendors. The assemble processes P_{A} are processes in which materials are assembled from parts, assemblies, or subassemblies. The server system 706 stores in the memory area 702 associations between the individual processes in the set of provide processes P_{P} and in the set of assemble processes P_{A}. The set of edges E is defined by the server system 706 as a union of a set of material edges E_{M} between the material nodes, a set of process precedence edges E_{P} between the assemble process nodes, and a set of providing edges E_{PM} between the provide process nodes. The server system 706 also stores data in the memory area 702 related to the sets of edges E, E_{M}, E_{P}, and E_{PM}. To create the directed acyclic graph, the server system 706 determines from the BOM the necessary elements, including materials M, processes P, and edges E. The server system 706 links nodes together in the BOM structure, using material edges E_{M}, based on those materials M that are connected or that depend on each other. Moreover, the server system 706 links nodes together in the process network, using process precedence edges E_{P} and providing edges E_{PM}, based on those processes P that are used to provide or assemble the materials.

After creating the directed acyclic graph, the server system 706 determines a status of a process in the process network. In some embodiments, the server system 706 determines a status of each process in the process network. In other embodiments, the server system 706 determines a status of only certain processes, such as those that have leaf nodes. Specifically, the server system 706 determines the status as a minimal canonical form of the process network with respect to one or more processes. The server system 706 then compares the minimal canonical form to a corresponding material node in the BOM structure. Accordingly, during setup of the directed acyclic graph, the server system 706 stores in the memory area 702 a link between each process node in the process network and a corresponding material node in the BOM structure that is a product of that process node. The BOM structure and/or the process network are valid if the status of the chosen process node matches the corresponding material node. If the two are do not match, then the BOM structure and/or the process network is invalid. The server system 706 stores a state of the BOM in the memory area 702.

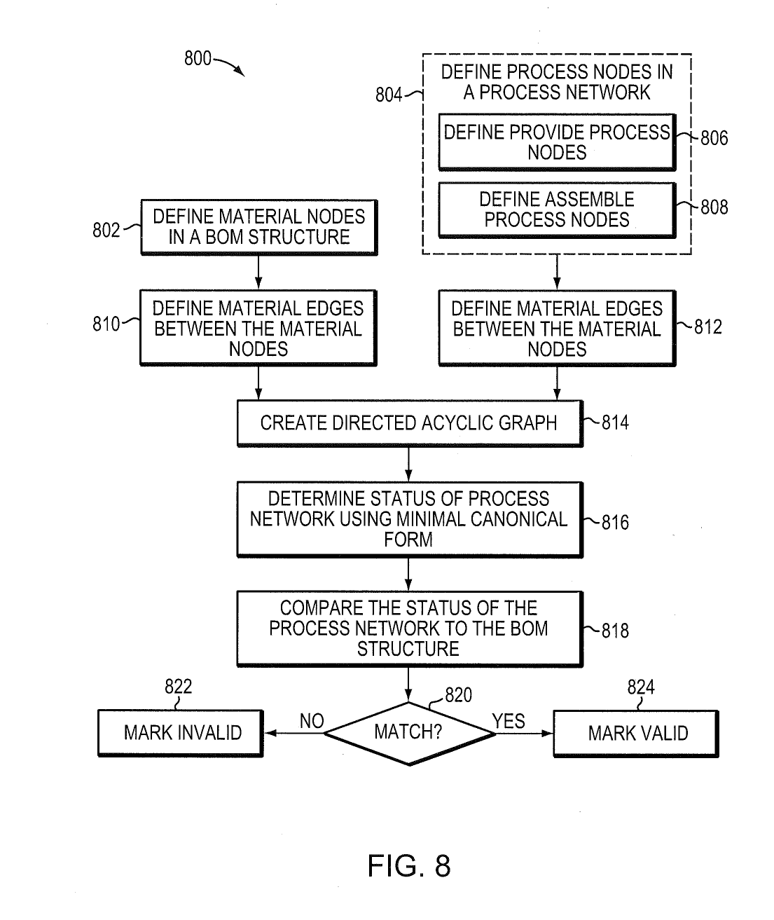

FIG. 8 is a flowchart 800 that illustrates an exemplary computer-implemented method for use in validating a BOM structure. In exemplary embodiment, a computer device, such as one having computer architecture 500 (shown in FIG. 5) or one belonging to computer system 700 (shown in FIG. 7), is used to validate the BOM structure using a process substantially similar to the process described above with respect to computer architecture 500 and computer system 700. It will be understood that processor 502 (shown in FIG. 5) and/or server system 706 (shown in FIG. 7) can execute the steps described above using, for example, computer program product that includes one or more non-transitory computer-readable storage media having computer-executable components for use in validating the BOM structure using a graph component and a status component that both interact with the processor of the computer device in order to validate a BOM structure using steps substantially similar to those described herein.

In an exemplary embodiment, the computer device defines 802 a set of material nodes representative of materials used in the BOM. The computer device also defines 804 a set of process nodes that are representative of processes used to assemble and/or procure the materials used in the BOM. Definition 804 of the process nodes includes defining 806 a set of provide process nodes representative of processes in which materials are provided whole and defining 808 a set of assemble process nodes representative of processes in which materials are assembled. Moreover, the computer device defines 810 a set of material edges that connect the material nodes in a given BOM structure and also defines 812 a set of process edges that connect the process nodes in a given process network. In some embodiments, the above definitions are made based on user input, such as the user constructing a BOM structure and defining the processes used to create the BOM structure. In other embodiments, the above definitions can be made automatically by the computer device. In such embodiments, the computer device may analyze a given BOM, generate one or more possible BOM structures that may be used to produce the BOM, and generate one or more possible process networks for each BOM structure generated. In some embodiments, the graph component of the computer-executable components described above causes a processor, such as processor 502 or a processor of server system 706, to define the items described above. Specifically, the graph component causes the processor to define a set of material nodes; define a set of process nodes, including provide process nodes and assemble process nodes; define a set of material edges; and define a set of process edges.

In an exemplary embodiment, the computer device then creates 814 a directed acyclic graph of a process based on the defined items above. The directed acyclic graph includes a BOM structure having a number of predefined material nodes connected by material edges. The directed acyclic graph also includes a process network having a number of predefined process nodes, including provide process nodes and/or assemble process nodes, connected by process edges. Notably, each leaf node in the BOM structure is linked to a corresponding leaf node in the process network. Similarly, each parent node in the BOM structure is linked to a corresponding parent node in the process network. In some embodiments, the graph component of the computer-executable components causes a processor to create the directed acyclic graph as just described.

In an exemplary embodiment, the computer device then determines 816 a status of one or more processes in the process network. For example, the computer device calculates a minimal canonical form of the process network. In some embodiments, the status component of the computer-executable components causes a processor to determine the status of the process network using a minimal canonical form. In an exemplary embodiment, the computer device then compares 818 the minimal canonical form to a corresponding material node in the BOM structure. The BOM structure and/or the process network are valid if the status of the chosen process node matches 820 the corresponding material node. If the two do not match (NO at step 820), then the BOM structure and/or the process network are marked 822 invalid in a memory area, such as memory area 504 (shown in FIG. 5) or memory area 702 (shown in FIG. 7). If the two items do match (YES at step 820), then the BOM structure and/or the process network are marked 824 as valid in the memory area. In some embodiments, the status component of the computer-executable components causes a processor to compare the status of the process network to the BOM structure and, based on the comparison, marks the BOM either valid or invalid in a memory area. Notably, the result of the comparison may also be displayed to a user via, for example, display device 518 (shown in FIG. 5).

Exemplary embodiments of computer-implemented methods, computer devices having embodiments of a computer architecture, computer systems, and computer program products for use in validating a BOM are described above in detail. The methods, devices, systems, and computer program products are not limited to the specific embodiments described herein but, rather, operations of the methods and/or components of the system and/or apparatus may be utilized independently and separately from other operations and/or components described herein. Further, the described operations and/or components may also be defined in, or used in combination with, other systems, methods, and/or apparatus, and are not limited to practice with only the systems, methods, and storage media as described herein.

A computer, such as those described herein, includes at least one processor or processing unit and a system memory. The computer typically has at least some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Combinations of any of the above are also included within the scope of computer readable media.

Although the present invention is described in connection with an exemplary computer system environment, embodiments of the invention are operational with numerous other general purpose or special purpose computer system environments or configurations. The computer system environment is not intended to suggest any limitation as to the scope of use or functionality of any aspect of the invention. Moreover, the computer system environment should not be interpreted as having any dependency or requirement relating to any one or combination of components illustrated in the exemplary operating environment. Examples of well known computer systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program components or modules, executed by one or more computers or other devices. Aspects of the invention may be implemented with any number and organization of components or modules. For example, aspects of the invention are not limited to the specific computer-executable instructions or the specific components or modules illustrated in the figures and described herein. Alternative embodiments of the invention may include different computer-executable instructions or components having more or less functionality than illustrated and described herein.

The order of execution or performance of the operations in the embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A computer-implemented method for validating a bill of material (BOM) structure having a plurality of nodes, said computer-implemented method comprising:
creating a directed acyclic graph of a process based on the BOM, wherein the directed acyclic graph includes the BOM structure and a process network;
determining a status of at least one process in the process network; and
comparing the status of the at least one process to an associated node.

2. A computer-implemented method in accordance with claim 1, wherein creating a directed acyclic graph comprises:
defining a set of material nodes representative of materials used in the BOM; and
defining a set of process nodes representative of processes used to at least one of assemble and procure the materials used in the BOM.

3. A computer-implemented method in accordance with claim 2, wherein defining a set of process nodes comprises:
defining a set of provide process nodes representative of processes in which materials are provided whole; and
defining a set of assemble process nodes representative of processes in which materials are assembled.

4. A computer-implemented method in accordance with claim 2, wherein creating a directed acyclic graph further comprises:
defining a set of process edges that connect the process nodes; and
defining a set of material edges that connect the material nodes.

5. A computer-implemented method in accordance with claim 1, wherein determining a status of at least one process comprises determining a minimal canonical form of the at least one process.

6. A computer-implemented method in accordance with claim 5, wherein comparing the status of the at least one process to an associated node comprises comparing the minimal canonical form of the at least one process to an associated node in the BOM structure.

7. A computer-implemented method in accordance with claim 1, further comprising determining the BOM structure and the process network are valid if the status of the at least one process matches the associated node in the BOM structure.

8. A computer for use in validating a bill of material (BOM) structure having a plurality of nodes, said computer comprising:
a memory area configured to store data representative of the plurality of nodes and the BOM structure; and
a processor coupled to said memory area, said processor configured to:
create a directed acyclic graph of a process based on the BOM, wherein the directed acyclic graph includes the BOM structure and a process network;
determine a status of at least one process in the process network; and
compare the status of the at least one process to an associated node.

9. A computer in accordance with claim 8, wherein said processor is further configured to:
define a set of material nodes representative of materials used in the BOM and store data representative of the material nodes in said memory area; and
define a set of process nodes representative of processes used to at least one of assemble and procure the materials used in the BOM and store data representative of the process nodes in said memory area.

10. A computer in accordance with claim 9, wherein said processor is further configured to:
define a set of provide process nodes representative of processes in which materials are provided whole and store data representative of the provide process nodes in said memory area; and
define a set of assemble process nodes representative of processes in which materials are assembled and store data representative of the assemble process nodes in said memory area.

11. A computer in accordance with claim 9, wherein said processor is further configured to:
define a set of process edges that connect the process nodes and store data representative of the process edges in said memory area; and
define a set of material edges that connect the material nodes and store data representative of the material edges in said memory area.

12. A computer in accordance with claim 8, wherein said processor is further configured to determine a minimal canonical form of the at least one process.

13. A computer in accordance with claim 12, wherein said processor is further configured to compare the minimal canonical form of the at least one process to an associated node in the BOM structure.

14. A computer in accordance with claim 8, wherein said processor is further configured to determine the BOM structure and the process network are valid if the status of the at least one process matches the associated node in the BOM structure.

15. A computer program product comprising:
one or more non-transitory computer-readable storage media having computer-executable components for use in validating a bill of material (BOM) structure having a plurality of nodes, said components comprising:
a graph component that when executed by a processor causes the processor to create a directed acyclic graph of a process based on the BOM, wherein the directed acyclic graph includes the BOM structure and a process network; and
a status component that when executed by a processor causes the processor to:
determine a status of at least one process in the process network; and
compare the status of the at least one process to an associated node.

16. A computer program product in accordance with claim 15, wherein said graph component further causes the processor to:
define a set of material nodes representative of materials used in the BOM; and
define a set of process nodes representative of processes used to at least one of assemble and procure the materials used in the BOM.

17. A computer program product in accordance with claim 16, wherein said graph component further causes the processor to:
define a set of provide process nodes representative of processes in which materials are provided whole; and
define a set of assemble process nodes representative of processes in which materials are assembled.

18. A computer program product in accordance with claim 16, wherein said graph component further causes the processor to:
define a set of process edges that connect the process nodes; and
define a set of material edges that connect the material nodes.

19. A computer program product in accordance with claim 15, wherein said status component further causes the processor to determine a minimal canonical form of the at least one process.

20. A computer program product in accordance with claim 19, wherein said status component further causes the processor to compare the minimal canonical form of the at least one process to an associated node in the BOM structure.
